(19) United States
(12) Patent Application Publication
(10) Pub. No.: US 2026/0108837 A1
(43) Pub. Date: Apr. 23, 2026

(54) PROCESSES AND APPARATUSES FOR PROVIDING A HYDROGEN STREAM

(71) Applicant: UOP LLC, Des Plaines, IL (US)

(72) Inventors: Rodrigo J. Lobo, Des Plaines, IL (US); Shubhra J. Bhadra, Naperville, IL (US); Moataz Sheha, Glenview, IL (US); Suryanarayana Murthy Konda Naga Venkata, Des Plaines, IL (US); Erick J. Bennett, III, New Lenox, IL (US); Rajasi Shukre, Bloomingdale, IL (US)

(21) Appl. No.: 18/924,807

(22) Filed: Oct. 23, 2024

(51) Int. Cl. B01D 53/02; C25B 15/08

(52) U.S. Cl. CPC B01D 53/02; C25B 15/083; C25B 15/085; B01D 2253/1124; B01D 2256/16; B01D 2257/104; B01D 2259/40086; B01D 2259/41

(57) ABSTRACT

Processes and apparatuses for producing a hydrogen stream by: producing an effluent stream in a reaction zone comprising a reactor, the effluent stream comprising hydrogen and oxygen; selectively adsorbing oxygen from the effluent stream in a separation zone, the separation zone comprising a plurality of vessels containing an adsorbent configured to selectively adsorb oxygen and provide a purified hydrogen stream; and regenerating spent adsorbent in a vessel from the plurality of vessels of the separation zone with at least a portion of the purified hydrogen stream to desorb oxygen as water.

### FIELD OF THE INVENTION

This invention relates generally to processes and apparatuses producing a hydrogen stream, and more particular to producing a hydrogen stream from an effluent of a reaction zone, and in particular, from an electrolyzer.

### BACKGROUND OF THE INVENTION

The production of hydrogen using water electrolysis is a market which is attracting attention and which is expected to grow significantly in the coming decade. However, in a water electrolyzer, the product hydrogen also contains a high concentration of oxygen (100 to 5,000 ppm to even 20,000 ppm). Unfortunately, many applications in which the produced hydrogen is used are not able to tolerate as much oxygen. For example, a hydrogen fuel cell requires <5ppm oxygen. Thus, oxygen removal is required for the hydrogen. The removal of oxygen is typically accomplished by reacting oxygen, in the presence of a catalyst, with hydrogen from the same stream.

While presumably effective for their intended purposes, it would be desirable to have additional effective and efficient ways to separate oxygen from a hydrogen stream and produce a high purity hydrogen stream.

### SUMMARY OF THE INVENTION

The present inventors have invented processes and apparatuses for removing oxygen from hydrogen with an adsorbent. This invention thus allows for the removal without recompression. This scheme requires little control. For this reason, this process might provide a differentiated solution for oxygen removal that has high recovery. Additionally, the present processes and apparatuses provide an increased hydrogen recovery.

Therefore, the present invention may be characterized, in at least one aspect, as providing a process for producing a hydrogen stream by: producing an effluent stream in a reaction zone comprising a reactor, the effluent stream comprising hydrogen and oxygen; selectively adsorbing oxygen from the effluent stream in a separation zone, the separation zone comprising a plurality of vessels containing an adsorbent configured to selectively adsorb oxygen and provide a purified hydrogen stream; and regenerating spent adsorbent in a vessel from the plurality of vessels of the separation zone with at least a portion of the purified hydrogen stream to desorb oxygen as water.

The reactor in the reaction zone may be an electrolyzer.

A first portion of the purified hydrogen stream may be recovered as a product stream and a second portion of the purified hydrogen stream may be the portion of the purified hydrogen stream utilized for regenerating spent adsorbent in one or more vessels of the separation zone. The process may also include regenerating spent adsorbent in a second vessel of the separation zone with a third portion of the purified hydrogen stream.

A first portion of the purified hydrogen stream may be the portion of the purified hydrogen stream utilized for regenerating spent adsorbent in a vessel of the separation zone. The process may further include regenerating spent adsorbent in a second vessel of the separation zone with a second portion of the purified hydrogen stream. The process may also include combining the first portion of the purified hydrogen stream and the second portion of the purified hydrogen stream after the portions have passed through the respective vessels.

An entirety of the purified hydrogen stream may be utilized for regenerating spent adsorbent in a vessel of the separation zone. The process may include regenerating spent adsorbent in a second vessel of the separation zone with the entirety of the purified hydrogen stream. The separation zone may include a plurality of vessels with spent adsorbent arranged in series.

In a second aspect, the present invention may be broadly characterized as providing a process for producing a hydrogen stream by: passing an effluent stream from a reaction zone to a separation zone, the reaction zone comprising an electrolyzer, the effluent stream comprising hydrogen and oxygen, and the separation zone comprising a plurality of vessels containing an adsorbent configured to selectively adsorb oxygen; selectively adsorbing oxygen from the effluent stream with the adsorbent in the separation zone and providing a purified hydrogen stream; and, passing at least a portion of the purified hydrogen stream to a vessel from the plurality vessels of the separation zone containing spent adsorbent to regenerate the spent adsorbent and desorb oxygen as water.

The process may also include recovering a first portion of the purified hydrogen stream is recovered as a product stream. A second portion of the purified hydrogen stream may be the portion of the purified hydrogen stream passed to the vessel with spent adsorbent. The process may further include passing a third portion of the purified hydrogen stream to a second vessel of the separation zone containing spent adsorbent to regenerate the spent adsorbent.

A first portion of the purified hydrogen stream may be the portion of the purified hydrogen stream passed to the vessel with spent adsorbent. The process may further include passing a second portion of the purified hydrogen stream to a second vessel of the separation zone containing spent adsorbent to regenerate the spent adsorbent.

An entirety of the purified hydrogen stream may be passed to the vessel with spent adsorbent. The process may include passing the entirety of the purified hydrogen stream to a second vessel of the separation zone containing spent adsorbent to regenerate the spent adsorbent. The separation zone may include a plurality of vessels with spent adsorbent arranged in series.

In a third aspect, the present invention may be generally characterized as providing an apparatus having: a reaction zone comprising a reactor and configured to produce an effluent stream comprising hydrogen and oxygen; a separation zone configured to receive the effluent stream and provide a purified hydrogen stream, the separation zone comprising plurality of vessels containing an adsorbent configured to selectively adsorb oxygen; and, a line configured to pass at least a portion of the purified hydrogen stream to a vessel from the plurality of vessels of the separation zone containing spent adsorbent to regenerate the spent adsorbent and desorb oxygen as water.

The reactor in the reaction zone may be an electrolyzer.

The apparatus may further include a plurality of lines each configured to separately pass a portion of the purified hydrogen stream to a vessel of the separation zone containing spent adsorbent. The line may be configured to pass an entirety of the purified hydrogen stream to the vessel containing spent adsorbent.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

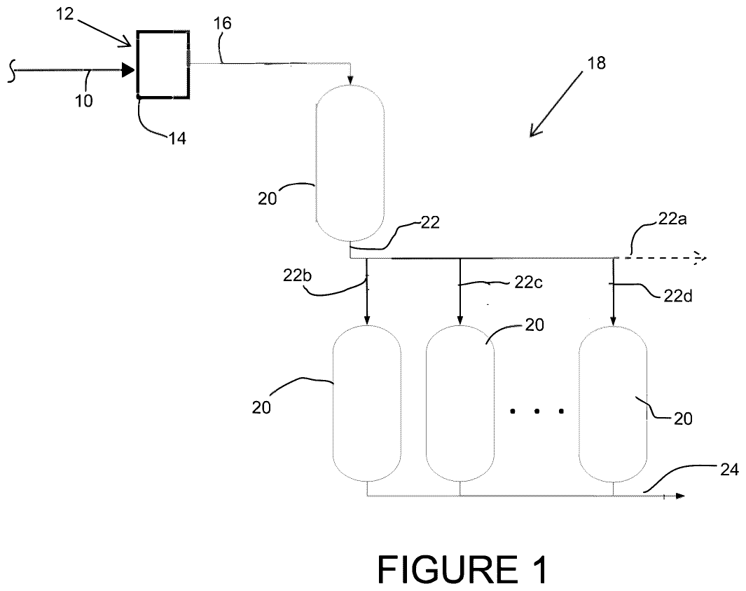

FIG. 1 shows a first embodiment for producing a hydrogen stream according to the present invention;

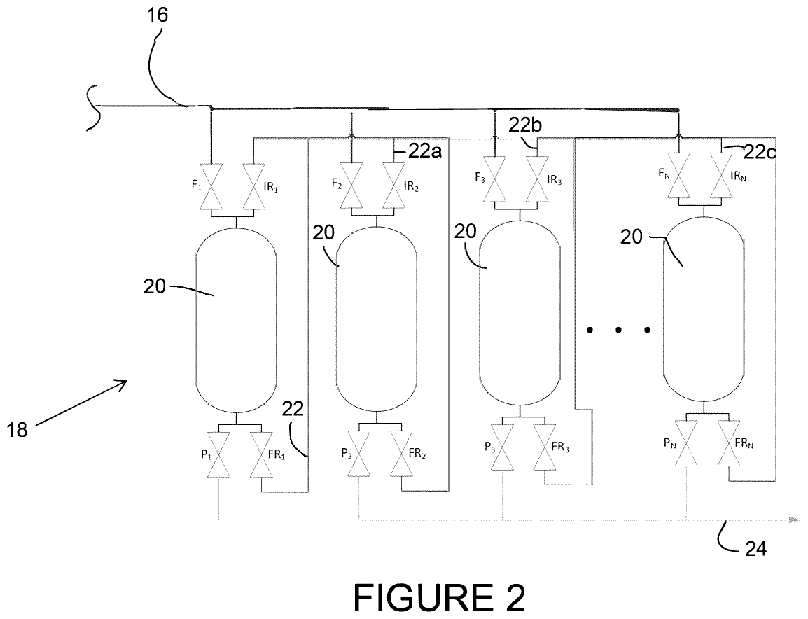

FIG. 2 shows a second embodiment for producing a hydrogen stream according to the present invention; and,

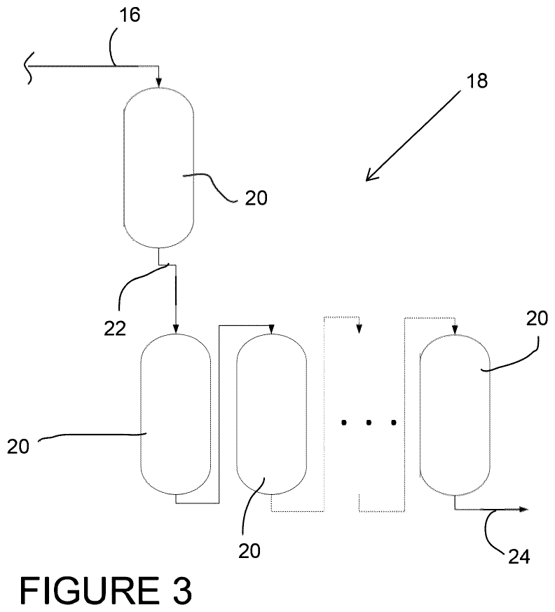

FIG. 3 shows a third embodiment for producing a hydrogen stream according to the present invention.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understating the embodiments of the present invention. In general, the same reference numbers will be used throughout the drawing(s) and accompanying written description to refer to the same or like parts.

### DETAILED DESCRIPTION OF THE INVENTION

As mentioned above, processes and apparatuses for producing a hydrogen stream have been invented. The general concept of this disclosure is to use a material that when fresh (aka reduced state) removes oxygen from the hydrogen stream by adsorbing the oxygen and converting it to water. Once this adsorbent is spent/depleted (or in an oxidized state), the adsorbent may be regenerated at approximately (e.g., +/−10%) the same temperature and pressure using oxygen-free hydrogen.

In a system with multiple beds, while one (or more) beds are removing oxygen from the contaminated stream, the other bed(s) can be regenerated using the purified product.

Once the bed removing oxygen is depleted (oxidized), the flow may be redirected towards a regenerated bed, and some (or all) of the oxygen-free (treated) hydrogen is directed towards the depleted bed to start regeneration where the oxygen has formed water with hydrogen and be removed. One example material is an adsorbent that comprises copper oxide. The present invention may be implemented in several ways by directing the hydrogen from the bed performing oxygen removal, towards the beds under regeneration.

With these general principles in mind, one or more embodiments of the present invention will be described with the understanding that the following description is not intended to be limiting.

As shown in FIGS. 1 to 3, a feed stream 10 comprising water is passed to a reaction zone 12 which includes a reactor 14, which in some embodiments is an electrolyzer. As is known, the electrolyzer receives electricity (not shown) and converts the water from the feed stream 10 into hydrogen and oxygen. An effluent stream 16 from the reaction zone contains, inter alia, hydrogen and oxygen. Although not depicted as such, a separate oxygen stream may also be provided from the electrolyzer.

Water may be separated (not shown) from the effluent stream 16 before the effluent stream 16 is passed to a separation zone 18. The separation zone 18 includes a plurality of vessels 20, with each vessel 20 containing an adsorbent configured to selectively adsorb oxygen and provide a purified hydrogen stream 22. Contemplated adsorbents to be utilized in the vessels 20 include adsorbents which comprise copper oxide.

Eventually, adsorbent in each of the vessels 20 will become spent and will need to be regenerated. Accordingly, according to the various embodiments, all or a portion of the purified hydrogen stream 22 may be used to desorb oxygen, from the adsorbent in the various vessels 20, as water.

For example, as shown in FIG. 1, a first portion 22a of the purified hydrogen stream 22 is recovered as a product stream. A second portion 22b of the purified hydrogen stream 22 is utilized for regenerating spent adsorbent in a vessel 20 of the separation zone 18. Multiple vessels 20 may undergo regeneration at the same time. For example, it is contemplated that, a third portion 22c and a fourth portion 22d of the purified hydrogen stream 22 may be utilized to regenerate additional vessels 20 of the separation zone 18. Any number of vessels 20 may be used. Spent regeneration gas 24 streams from all vessels 24 may be combined.

In the embodiment of FIG. 1, two hydrogen streams are provided, the portion 22a of the product stream 22 and the (combined) spent regeneration gas 24 from the vessels 20 undergoing regeneration. Both hydrogen streams 22a, 24 have a low oxygen content.

Turning to FIG. 2, it is also contemplated that the entirety of the purified hydrogen stream 22 is utilized to regenerate the vessels 20 which are arranged in parallel. Thus, the purified hydrogen stream 22 is split into a plurality of portions 22a, 22b, 22c that together equal the entirety of the purified hydrogen stream 22. Each portion 22a, 22b, 22c is passed to a vessel 20 for regeneration and the spent regeneration gas 24 may be recovered as the hydrogen product.

Depicted in FIG. 2, but not labeled for clarity, valves may be used to direct and control the flow of the various streams as is known.

Turning to FIG. 3, the vessels may also be arranged in series. Accordingly, an entirety of the purified hydrogen stream is passed to at least a first vessel to regenerate spent adsorbent in the vessel. Depending on the number of vessels 20, the entirety of the purified hydrogen stream 22 (as spent regeneration gas) may be passed to a second vessel 20 (and so on) to regenerate spent adsorbent in the second (or subsequent) vessel 20. The net spent regeneration gas 24 may be recovered as the hydrogen product.

### Experiments

A bed of copper oxide-based adsorbent, containing a total of 6 g of total CuO, was placed in a stream hydrogen stream flowing at 60° C. A first adsorption cycle was initiated by introducing a stream with hydrogen and containing 3000 ppm of oxygen into a reactor. The oxygen was consumed until the adsorbent was fully depleted (at ˜30 mg of oxygen/g of adsorbent). Once depleted the oxygen concentration in the stream exiting the reactor increased.

To regenerate the adsorbent, the spent adsorbent was placed under a hydrogen stream free of oxygen for an extended period of time.

A second adsorption cycle was initiated by introducing the stream with hydrogen and 3000 ppm of oxygen into the reactor. The oxygen was consumed until the adsorbent was fully depleted (at ˜25 mg of oxygen/g of adsorbent). Again, once depleted the oxygen concentration in the stream exiting the reactor increased.

Accordingly, the adsorbent was shown to remove oxygen from the stream and to be regenerated with a hydrogen stream.

### Specific Embodiments

While the following is described in conjunction with specific embodiments, it will be understood that this description is intended to illustrate and not limit the scope of the preceding description and the appended claims.

A first embodiment of the invention is a process for producing a hydrogen stream, the process comprising producing an effluent stream in a reaction zone comprising a reactor, the effluent stream comprising hydrogen and oxygen; selectively adsorbing oxygen from the effluent stream in a separation zone, the separation zone comprising a plurality of vessels containing an adsorbent configured to selectively adsorb oxygen and provide a purified hydrogen stream; regenerating spent adsorbent in a vessel from the plurality of vessels of the separation zone with at least a portion of the purified hydrogen stream to desorb oxygen as water. An embodiment of the invention is one, any or all of prior embodiments in this paragraph up through the first embodiment in this paragraph, wherein the reactor in the reaction zone comprises an electrolyzer. An embodiment of the invention is one, any or all of prior embodiments in this paragraph up through the first embodiment in this paragraph, wherein a first portion of the purified hydrogen stream is recovered as a product stream, and wherein a second portion of the purified hydrogen stream is the portion of the purified hydrogen stream utilized for regenerating spent adsorbent in a vessel of the separation zone. An embodiment of the invention is one, any or all of prior embodiments in this paragraph up through the first embodiment in this paragraph, further comprising regenerating spent adsorbent in a second vessel of the separation zone with a third portion of the purified hydrogen stream. An embodiment of the invention is one, any or all of prior embodiments in this paragraph up through the first embodiment in this paragraph, wherein a first portion of the purified hydrogen stream is the portion of the purified hydrogen stream utilized for regenerating spent adsorbent in a vessel of the separation zone, and wherein the process further comprises regenerating spent adsorbent in a second vessel of the separation zone with a second portion of the purified hydrogen stream. An embodiment of the invention is one, any or all of prior embodiments in this paragraph up through the first embodiment in this paragraph, further comprising combining the first portion of the purified hydrogen stream and the second portion of the purified hydrogen stream after the portions have passed through the respective vessels. An embodiment of the invention is one, any or all of prior embodiments in this paragraph up through the first embodiment in this paragraph, wherein an entirety of the purified hydrogen stream is utilized for regenerating spent adsorbent in a vessel of the separation zone. An embodiment of the invention is one, any or all of prior embodiments in this paragraph up through the first embodiment in this paragraph, further comprising regenerating spent adsorbent in a second vessel of the separation zone with the entirety of the purified hydrogen stream. An embodiment of the invention is one, any or all of prior embodiments in this paragraph up through the first embodiment in this paragraph, wherein the separation zone comprises a plurality of vessels with spent adsorbent arranged in series.

A second embodiment of the invention is a process for producing a hydrogen stream, the process comprising passing an effluent stream from a reaction zone to a separation zone, the reaction zone comprising an electrolyzer, the effluent stream comprising hydrogen and oxygen, and the separation zone comprising a plurality of vessels containing an adsorbent configured to selectively adsorb oxygen; selectively adsorbing oxygen from the effluent stream with the adsorbent in the separation zone and providing a purified hydrogen stream; and, passing at least a portion of the purified hydrogen stream to a vessel from the plurality vessels of the separation zone containing spent adsorbent to regenerate the spent adsorbent and desorb oxygen as water. An embodiment of the invention is one, any or all of prior embodiments in this paragraph up through the second embodiment in this paragraph, further comprising recovering a first portion of the purified hydrogen stream is recovered as a product stream, and wherein a second portion of the purified hydrogen stream is the portion of the purified hydrogen stream passed to the vessel with spent adsorbent. An embodiment of the invention is one, any or all of prior embodiments in this paragraph up through the second embodiment in this paragraph, further comprising passing a third portion of the purified hydrogen stream to a second vessel of the separation zone containing spent adsorbent to regenerate the spent adsorbent. An embodiment of the invention is one, any or all of prior embodiments in this paragraph up through the second embodiment in this paragraph, wherein a first portion of the purified hydrogen stream is the portion of the purified hydrogen stream passed to the vessel with spent adsorbent, and wherein the process further comprises passing a second portion of the purified hydrogen stream to a second vessel of the separation zone containing spent adsorbent to regenerate the spent adsorbent. An embodiment of the invention is one, any or all of prior embodiments in this paragraph up through the second embodiment in this paragraph, wherein an entirety of the purified hydrogen stream is passed to the vessel with spent adsorbent. An embodiment of the invention is one, any or all of prior embodiments in this paragraph up through the second embodiment in this paragraph, further comprising passing the entirety of the purified hydrogen stream to a second vessel of the separation zone containing spent adsorbent to regenerate the spent adsorbent. An embodiment of the invention is one, any or all of prior embodiments in this paragraph up through the second embodiment in this paragraph, wherein the separation zone comprises a plurality of vessels with spent adsorbent arranged in series.

A third embodiment of the invention is an apparatus for producing a hydrogen stream, the apparatus comprising a reaction zone comprising a reactor and configured to produce an effluent stream comprising hydrogen and oxygen; a separation zone configured to receive the effluent stream and provide a purified hydrogen stream, the separation zone comprising plurality of vessels containing an adsorbent configured to selectively adsorb oxygen; and, a line configured to pass at least a portion of the purified hydrogen stream to a vessel from the plurality of vessels of the separation zone containing spent adsorbent to regenerate the spent adsorbent and desorb oxygen as water. An embodiment of the invention is one, any or all of prior embodiments in this paragraph up through the third embodiment in this paragraph, wherein the reactor in the reaction zone comprises an electrolyzer. An embodiment of the invention is one, any or all of prior embodiments in this paragraph up through the third embodiment in this paragraph, further comprising a plurality of lines each configured to separately pass a portion of the purified hydrogen stream to a vessel of the separation zone containing spent adsorbent. An embodiment of the invention is one, any or all of prior embodiments in this paragraph up through the third embodiment in this paragraph, wherein the line is configured to pass an entirety of the purified hydrogen stream to the vessel containing spent adsorbent.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for producing a hydrogen stream, the process comprising:
producing an effluent stream in a reaction zone comprising a reactor, the effluent stream comprising hydrogen and oxygen;
selectively adsorbing oxygen from the effluent stream in a separation zone, the separation zone comprising a plurality of vessels containing an adsorbent configured to selectively adsorb oxygen and provide a purified hydrogen stream;
regenerating spent adsorbent in a vessel from the plurality of vessels of the separation zone with at least a portion of the purified hydrogen stream to desorb oxygen as water.

2. The process of claim 1, wherein the reactor in the reaction zone comprises an electrolyzer.

3. The process of claim 1, wherein a first portion of the purified hydrogen stream is recovered as a product stream, and
wherein a second portion of the purified hydrogen stream is the portion of the purified hydrogen stream utilized for regenerating spent adsorbent in a vessel of the separation zone.

4. The process of claim 3, further comprising:
regenerating spent adsorbent in a second vessel of the separation zone with a third portion of the purified hydrogen stream.

5. The process of claim 1, wherein a first portion of the purified hydrogen stream is the portion of the purified hydrogen stream utilized for regenerating spent adsorbent in a vessel of the separation zone, and wherein the process further comprises:
regenerating spent adsorbent in a second vessel of the separation zone with a second portion of the purified hydrogen stream.

6. The process of claim 5, further comprising:
combining the first portion of the purified hydrogen stream and the second portion of the purified hydrogen stream after the first and second portions have passed through the respective vessels.

7. The process of claim 1, wherein an entirety of the purified hydrogen stream is utilized for regenerating spent adsorbent in a vessel of the separation zone.

8. The process of claim 7, further comprising:
regenerating spent adsorbent in a second vessel of the separation zone with the entirety of the purified hydrogen stream.

9. The process of claim 7, wherein the separation zone comprises a plurality of vessels with spent adsorbent arranged in series.

10. A process for producing a hydrogen stream, the process comprising:
passing an effluent stream from a reaction zone to a separation zone, the reaction zone comprising an electrolyzer, the effluent stream comprising hydrogen and oxygen, and the separation zone comprising a plurality of vessels containing an adsorbent configured to selectively adsorb oxygen;
selectively adsorbing oxygen from the effluent stream with the adsorbent in the separation zone and providing a purified hydrogen stream; and,
passing at least a portion of the purified hydrogen stream to a vessel from the plurality vessels of the separation zone containing spent adsorbent to regenerate the spent adsorbent and desorb oxygen as water.

11. The process of claim 10, further comprising:
recovering a first portion of the purified hydrogen stream is recovered as a product stream, and
wherein a second portion of the purified hydrogen stream is the portion of the purified hydrogen stream passed to the vessel with spent adsorbent.

12. The process of claim 11, further comprising:
passing a third portion of the purified hydrogen stream to a second vessel of the separation zone containing spent adsorbent to regenerate the spent adsorbent.

13. The process of claim 10, wherein a first portion of the purified hydrogen stream is the portion of the purified hydrogen stream passed to the vessel with spent adsorbent, and wherein the process further comprises:
passing a second portion of the purified hydrogen stream to a second vessel of the separation zone containing spent adsorbent to regenerate the spent adsorbent.

14. The process of claim 10, wherein an entirety of the purified hydrogen stream is passed to the vessel with spent adsorbent.

15. The process of claim 14, further comprising:
passing the entirety of the purified hydrogen stream to a second vessel of the separation zone containing spent adsorbent to regenerate the spent adsorbent.

16. The process of claim 14, wherein the separation zone comprises a plurality of vessels with spent adsorbent arranged in series.

17. An apparatus for producing a hydrogen stream, the apparatus comprising:
a reaction zone comprising a reactor and configured to produce an effluent stream comprising hydrogen and oxygen;
a separation zone configured to receive the effluent stream and provide a purified hydrogen stream, the separation zone comprising plurality of vessels containing an adsorbent configured to selectively adsorb oxygen; and,
a line configured to pass at least a portion of the purified hydrogen stream to a vessel from the plurality of vessels of the separation zone containing spent adsorbent to regenerate the spent adsorbent and desorb oxygen as water.

18. The apparatus of claim 17, wherein the reactor in the reaction zone comprises an electrolyzer.

19. The apparatus of claim 17, further comprising a plurality of lines each configured to separately pass a portion of the purified hydrogen stream to a vessel of the separation zone containing spent adsorbent.

20. The apparatus of claim 17, wherein the line is configured to pass an entirety of the purified hydrogen stream to the vessel containing spent adsorbent.
